(19) United States
(12) Patent Application Publication
(10) Pub. No.: US 2009/0241855 A1
(43) Pub. Date: Oct. 1, 2009

(54) VISION CONE COLLAR

(76) Inventors: Michael L. Stocki, Lake Elsinore, CA (US); Jan B. Wensink, Lake Elsinore, CA (US)

Correspondence Address: AVERILL & VARN, 8244 PAINTER AVE., WHITTIER, CA, 90602, US

(21) Appl. No.: 12/058,610

(22) Filed: Mar. 28, 2008

(51) Int. Cl. A61D 9/00; A01K 15/04; A01K 13/00

(52) U.S. Cl. 119/815

(57) ABSTRACT

An improved animal medical collar includes openings allowing pets, domestic, and captive wild animals wearing the medical collar to freely see and smell their surroundings while preventing access to a wound or surgical area. The openings are sized and spaced to allow the animal to view and smell it's surroundings and provides increased air circulation around the animal's head. Providing such viewing and perception of odors and scents relieves the stress and anxiety the animal would otherwise experience.

### BACKGROUND OF THE INVENTION

The present invention relates to animal medical collars and to dog medical collars in particular.

It is often necessary or desired to fit a restrictive medical collar to an animal to restrict the animal from chewing or licking wounds, stitches, casts or braces, and the like. These medical collars are generally frusto conical in shape and fit around the animal neck and open forwardly around the animals head. U.S. Pat. No. 5,797,354 for “Collar for Mounting Around the Neck of an Animal,” discloses such a medical collar made from a flat arced shaped piece of material which may be folded into the frusto conical shape around an animal's neck and head to prevent the animal from chewing or licking an injury. The '354 patent is herein incorporated by reference in it's entirety.

U.S. Pat. No. 6,382,140 for “Apparatus and Method for Encapsulating an Animal's Head,” discloses a clear spherical medical collar however, such clear colors affect the animals vision and smell, and do not provide a natural experience to the animal.

Unfortunately, these known designs for Cone Collars only permit the animal to see straight ahead (tunnel vision effect). While such collars are successful in preventing the undesirable behavior, they also often cause the animal wearing the medical collar to be nervous and may result in accidents and possibly further injury. Without peripheral vision the animal is in effect wearing blinders and will unwittingly catch, bump, or rub the collar on furniture, walls, doors and other objects creating an unsafe environment for both the animal and it's surrounding. The animal will naturally do this as a means of navigating its way, similar to a blind person adjusting their attitude with a cane or hands and arms outstretched. Many animals become so disoriented wearing a cone collar with their peripheral vision blinded, they enter into a state of depression and/or paranoia. Some animals refuse to eat. Others will not move about and most just stumble over things not visible from their perspective.

### BRIEF SUMMARY OF THE INVENTION

The present invention addresses the above and other needs by providing an improved animal medical collar which includes openings allowing pets, domestic, and captive wild animals wearing the medical collar to freely see and smell their surroundings while preventing access to a wound or surgical area. The openings are sized and spaced to allow the animal to view and smell it's surroundings and provides increased air circulation around the animal's head. Providing such viewing and perception of odors and scents relieves the stress and anxiety the animal would otherwise experience.

The improved medical collar of the present invention is created from a pliable, clear or semi-opaque, sheet plastic material, die cut to a semi-circle shape with a smaller inner semi-circle inset boundary incorporating collar and assembly attachment arrows. The die cut shape also contains multiple perforations of different size and shape windows throughout the body of the cone that may easily be removed. The veterinarian or animal husband simply positions the improved medical collar checking size, location of the eyes and ears of the animal in relation to the position of the windows. Selection and removal of windows that enhance peripheral vision, hearing, and ventilation outside the reach of the protected area will create a custom application. Thus providing the beneficial qualities of the design to be achieved without compromising the protective elements. The semi-circle plastic shape is then rolled about a central axis to form a truncated cone and assembly is completed with the fitting of the attachment arrows into designated slots accommodating animal's size to achieve a snug fit. The improved medical collar design also allows for this customization of the collar to be concurrent with the healing progression of the animals affected area(s) and a safer environment for the animal while the collar is in place.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of a prior art medical collar worn by a dog.

FIG. 1B is a front view of the prior art medical collar worn by the dog.

FIG. 2A is a side view of an improved medical collar according to the present invention worn by the dog.

FIG. 2B is a front view of the improved medical collar according to the present invention worn by the dog.

FIG. 3 shows the improved medical collar lying flat.

FIG. 4 shows the improved medical collar rolled into a cone.

FIG. 5 is a slot cut-out of the improved medical collar according to the present invention.

FIG. 6 is a round cut-out of the improved medical collar according to the present invention.

FIG. 7 shows a side view of the dog wearing the prior art medical collar and the resulting loss of vision.

FIG. 8 shows a side view of the dog wearing the improved medical collar according to the present invention with openings providing vision and smell.

FIG. 9 shows a side view of the dog wearing a second embodiment of an improved medical collar according to the present invention with fixed openings providing vision and smell

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

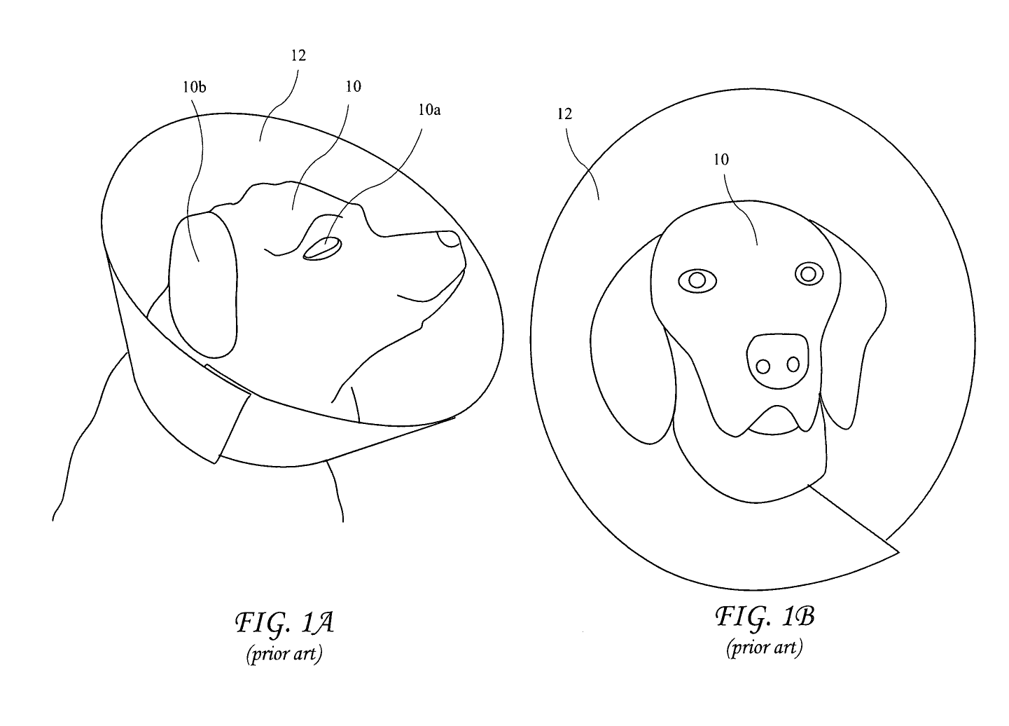

A side view of a prior art medical collar 12 worn by a dog 10 is shown in FIG. 1A, and a front view of the prior art medical collar 12 worn by the dog 10 is shown in FIG. 1B. The prior art medical collar 12 prevents or restrict the dog 10 from chewing or licking wounds, stitches, casts or braces, and the like. Unfortunately, the prior art collar 12 prevents the dog 10 from seeing and smelling it's surroundings often causing the dog 10 to be nervous and may result in accidents and possibly further injury.

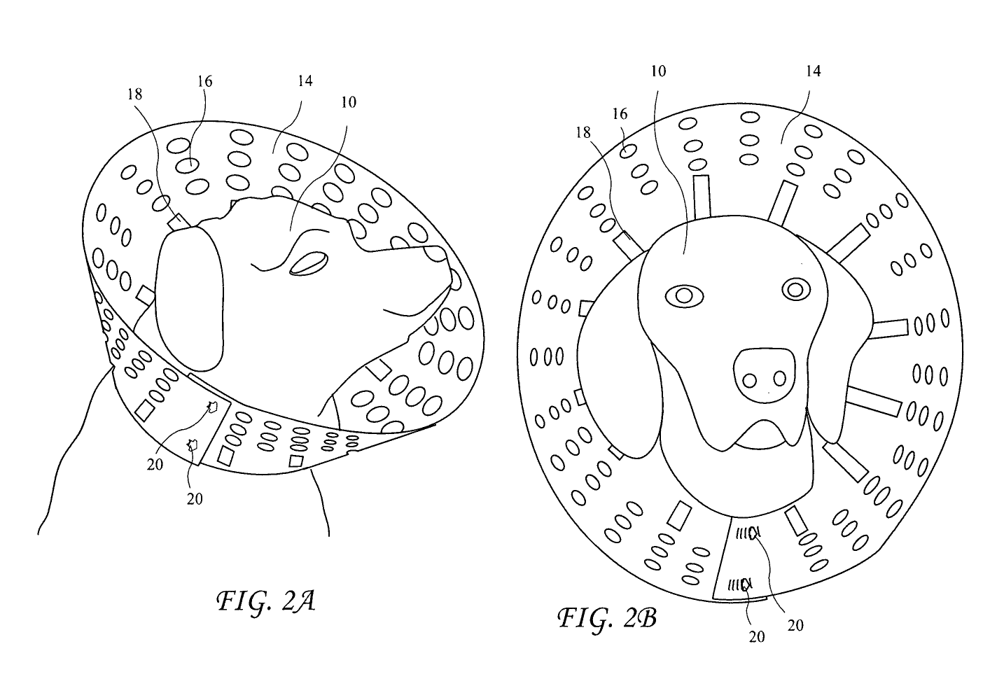

A side view of an improved medical collar 14 according to the present invention worn by the dog 10 is shown in FIG. 2A and a front view of the improved medical collar 14 worn by the dog 10 is shown in FIG. 2B. The improved medical collar 14 includes a multiplicity of round and slotted openings 16 and 18 allowing the dog 10 to see and smell it's surroundings. The openings 16 and 18 may be of varying size and shape, and provide sufficient vision and smell to the dog 10 to allow the dog 10 to have normal perception of it's surroundings. Preferably, the openings 16 and 18 are in the top half 54 of the medical collar 14 (see FIG. 9) and have an area of between approximately 25 percent and approximately 50 percent of the top half 54, and more preferably the openings 16 and 18 have an area of approximately 50 percent of the top half 54.

The improved medical collar 14 is formed from a flat sheet having an inside arc 14a, an outside arc 14b, a first end 14c connecting the inside arc 14a to the outside arc 14b, and a second end 14d connecting opposite ends of the inside arc 14a to the outside arc 14b. The second end 14d attachable to the first end 14c to form the flat sheet into a truncated cone.

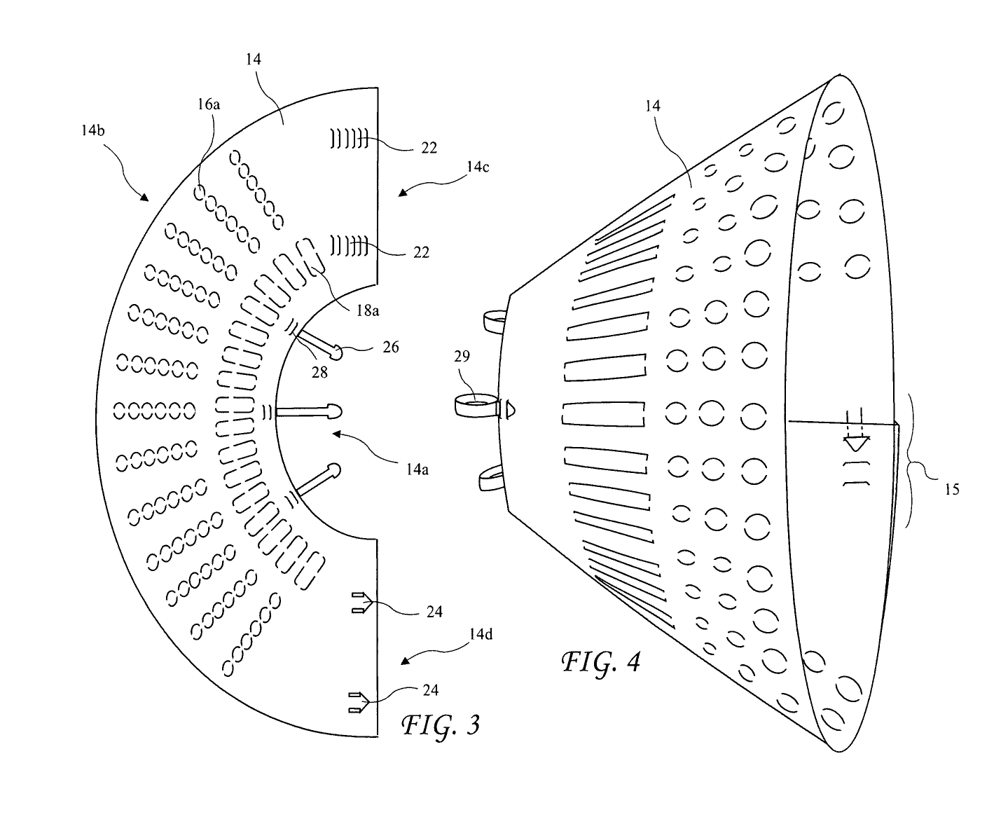

The improved medical collar 14 is shown lying flat forming a semi-circle in FIG. 3 and rolled into a cone in FIG. 4. The openings 16 and 18 are provided as cut-outs 16a and 18a which may be punched out to create the number of openings desires. The improved medical collar 14 further includes slots 22 and arrows 24 which are engaged to form the collar 14 into a cone around a dog's, or other animal's, neck. The improved medical collar 14 also includes straps 26 and slots 28 to form loops 29 for attaching the medical collar 14 to a typical dog collar such as a leash is attached to.

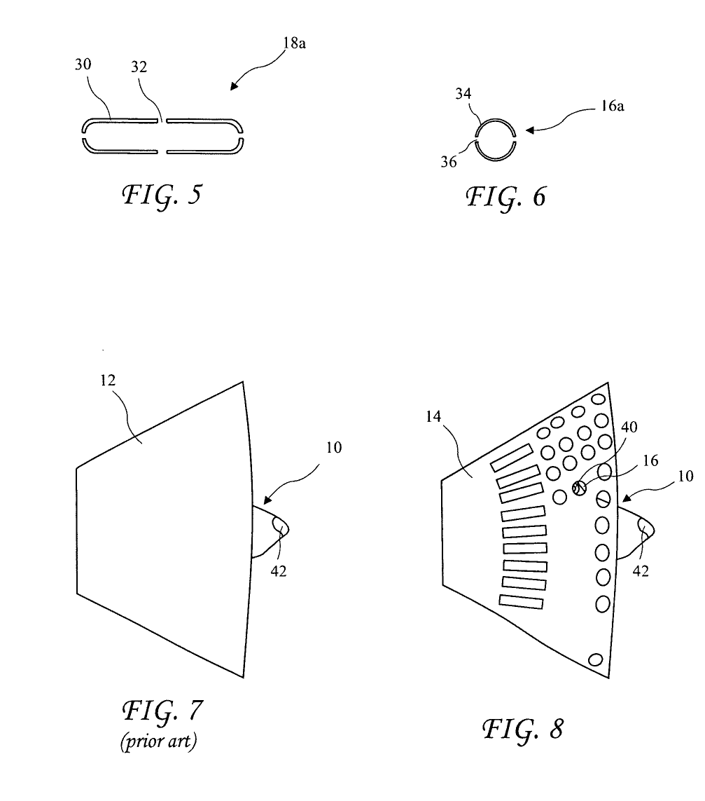

The slot cut-out 18a of the improved medical collar 14 is shown in detail in FIG. 5 and the round cut-out 16a is shown in detail in FIG. 6. The slot cut-outs include four cuts or slices 30 forming the shape of the slot and four tabs 32 which may be cut, torn, or broken to open the slot 18a. The round cut-outs 16a include two semicircular cuts or slices 34 forming the shape of the round cut-out 16a and two tabs 32 which may be cut, torn, or broken to open the round cut-out 16a.

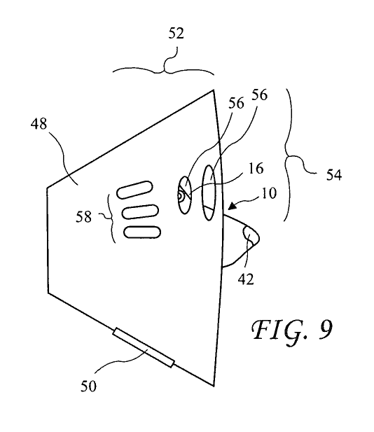

A side view of the dog 10 wearing the prior art medical collar 12 with the resulting loss of vision is shown in FIG. 7 and a side view of the dog 10 wearing the improved medical collar 14 according to the present invention with openings 16 and 18 providing vision and smell is shown in FIG. 8. An eye 40 of the dog 10 is visible though the opening 40 thereby providing vision to the dog. In many instances, the entire nose 42 of the dog 10 is recessed inside the prior art medical collar 12 thereby limiting the dog's ability to smell objects in it's surroundings.

A side view of the dog 10 wearing a second embodiment of an improved medical collar 48 according to the present invention with fixed openings 56 and 58 providing vision and smell, and directional hearing respectively to the dog 10. The medical collar 48 has a forward half 52 and an upper half 54. The fixed openings 56 and 58 are positioned proximal to the eyes 10a and ears 10b (see FIG. 1A) of the dog 10, and are preferably positioned in the intersection of the forward half 52 and the upper half 54 of the medical collar 48 on opposite sides of the medical collar 48. The openings 56 and 58 are preferably pairs of openings on opposite sides of the medical collar 48. The bottom half of the medical collar 14 and 48 is preferably solid or substantially solid to prevent licking. While some holes may be present in the bottom half, for example for attaching ends 14a and 14d (see FIG. 3) the substantially solid medical collar does not have openings large enough for the dog to lick through.

The orientation of the medical collar 14 or 48 is preferably maintained by a weighted bottom. For example, the overlapped portion 15 provides weight to tend to provide a rotational orientation, and when a leash type dog collar is attached to the medical collar using the loop 29 (see FIG. 4), the leash collar may be positioned with a heavy buckle aligned with the overlapped portion 15 to help maintain the medical collar orientation. Additionally, a weight 50 may be attached to the bottom of the medical collar 48 to maintain the rotational position of the medical collar 48 on the dog 10 (see FIG. 4).

In instances where the weight of the collar is not sufficient to maintain the orientation of the collar, and clip to grasp some of the dog's hair, or a harness may be used to maintain the position of the medical collar 14 or 48 on the dog.

While the invention herein disclosed has been described by means of specific embodiments and applications thereof, numerous modifications and variations could be made thereto by those skilled in the art without departing from the scope of the invention set forth in the claims.

I claim:

1. An improved medical collar comprising:
a semi-circular sheet having:
an inside arc;
an outside arc;
a first end extending from the inside arc to the outside arc; and
a second end opposite the first end and extending from the inside arc to the outside arc, the second end attachable to the first end to form the semi-circular sheet into a truncated cone;
openings in the semi-circular sheet for providing vision and smell to an animal wearing the collar.

2. The improved medical collar of claim 1, wherein the openings comprise round openings.

3. The improved medical collar of claim 1, wherein the openings comprise slotted openings.

4. The improved medical collar of claim 1, wherein the openings comprise cutouts opened by selectively cutting tabs.

5. The improved medical collar of claim 4, wherein the cutouts comprise round cutouts and slotted cut-outs.

6. The improved medical collar of claim 1, wherein the openings are in a forward half of the medical collar.

7. The improved medical collar of claim 6, wherein the openings are in an upper half of the medical collar.

8. The improved medical collar of claim 7, wherein the openings comprise pairs of openings on opposite sides of the medical collar for allowing vision to both eyes.

9. The improved medical collar of claim 8, further including a weight on the bottom of the medical collar to rotationally fix the medical collar with respect to the eyes of the dog.

10. The improved medical collar of claim 9, wherein the bottom half of the medical collar is substantially solid to prevent licking.

11. An improved medical collar comprising:
a semi-circular sheet having:
an inside arc;
an outside arc;
a first end connecting the inside arc to the outside arc; and
a second end connecting the inside arc to the outside arc, the second end attachable to the first end to form the collar into a truncated cone;
selectively opened cut-outs in the sheet for providing vision and smell to an animal wearing the collar.

12. An improved medical collar comprising:
a semi-circular sheet having:
an inside arc;
an outside arc;
a first end connecting the inside arc to the outside arc; and
a second end connecting the inside arc to the outside arc, the second end attachable to the first end to form the collar into a truncated cone;
pairs of pre-cut opening in the sheet for providing vision and smell to an animal wearing the collar.

13. The improved medical collar of claim 12, further including a weight on the bottom of the medical collar to rotationally fix the medical collar with respect to the eyes of the dog.
